(19) United States
(12) Patent Application Publication
(10) Pub. No.: US 2012/0207588 A1
(43) Pub. Date: Aug. 16, 2012

(54) Portable Hydro Electric Generator

(76) Inventor: Aaron M. Schmidt, San Diego, CA (US)

(21) Appl. No.: 13/367,181

(22) Filed: Feb. 6, 2012

Related U.S. Application Data
(60) Provisional application No. 61/462,642, filed on Feb. 4, 2011.

(51) Int. Cl. F01D 13/00; H02K 21/12; F03B 3/00

(52) U.S. Cl. 415/121.3; 310/156.01

(57) ABSTRACT

The invention provides a self-contained generator which converts the gravitational potential energy of water into electrical power, while continually replenishing its water reservoir. The Hydro Electric Portable Generator is a free-standing, gravity-fed, micro-Hydro Electric turbine-style generator. The water is provided from an elevated tank and the flow pressure is provided through the penstock, a series of diminishing diameter reducer pipes, as the water approaches the turbine.

### CLAIM OF PRIORITY

This patent application claims priority under 35 USC 119(e)(1) from U.S. Provisional Patent Application Ser. No. 61/462,642 filed Feb. 4, 2011, of common inventorship herewith entitled, “Hydro Electric Portable generator.”

### FIELD OF THE INVENTION

The present invention pertains to the field of generators, and more specifically to the field of hydro electric turbine generators.

### BACKGROUND OF THE INVENTION

The prior art has put forth several designs for hydro electric or gravity generators. Among these are:

U.S. Pat. No. 7,222,487 to William G. Hinkley describes a portable electricity-generating gravity-driven wheel system with fluid receptacles.

U.S. Pat. No. 6,817,180 to Edwin Newman describes portable electricity-generating gravity-driven water system that uses a buoyancy motor formed in a U-tube with separate air-filled tanks.

U.S. Pat. No. 5,755,553 to Prasert Laemthongsawad describes an improved water turbine apparatus with a rotating waterwheel with water-receiving buckets.

None of these prior art references describe the present invention.

### SUMMARY OF THE INVENTION

It is an object of the present invention to provide an improved small-scale portable hydro electric self-replenishing generator.

### BRIEF DESCRIPTION OF THE DRAWINGS

FIG. 1 is a schematic diagram of the generator of the present invention.

FIG. 2 is a schematic diagram Showing the internal mechanism of the low flow turbine of the present invention.

FIG. 3 is a diagram of the non-cogging permanent magnet generator (PMG) of the present invention.

FIG. 4 is a diagram showing the magnetic bearing of the present invention.

FIG. 5 is a front view of the hydro electric portable generator of the present invention showing the base, tank, reducer pipes, low flow generator, fill pipe, and boost pump.

FIG. 6 is a front view of the low flow generator of the present invention.

FIG. 7 shows a perspective view of the boost pump attached to the ascending fill pipe of the generator of the present invention.

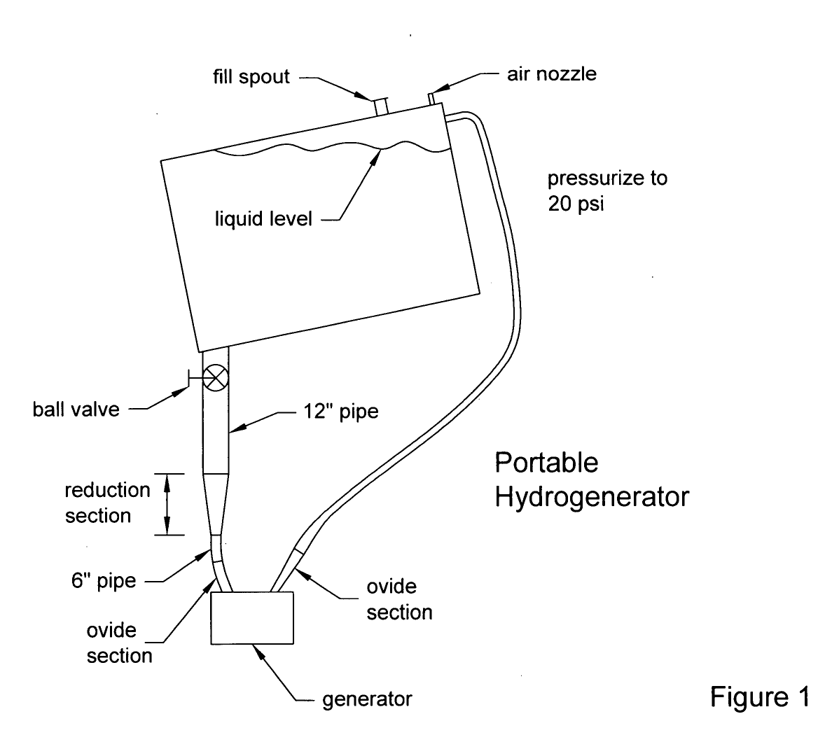

### DETAILED DESCRIPTION OF THE INVENTION

In a world hungry for clean and efficient sources of energy, inventors and engineers have turned their efforts toward capturing virtually unlimited supplies of energy from moving winds, sunlight, the ocean tides, the nuclei of atoms, and other renewable energy that might replace our current dependence on finite supplies of the fossil fuels, coal, oil, natural gas, methane, oil sands and shale, bound up in earth's sedimentary rocks. Beyond the search for new energy sources, inventors and engineers seek ever higher levels of efficiency in the energy converting machines upon which we rely, from hybrid automobiles to household electric appliances.

Energy can be neither created nor destroyed, but only converted from one form to another. An automobile takes the chemical potential energy of gasoline and, through the heat of combustion and the expansion of gases, converts that potential energy into the kinetic energy that turns the driveshaft and moves the car. Batteries, too, are a source of potential energy. When connected to an all electrical circuit, batteries release a stream of electrons forming an electric current, which can then be converted into work. In a simple generator, a coil of conducting wire is placed between two magnets and spun, the magnetic field inducing an electric current. The generator's alternating current, in which electrons move back and forth, differs from a battery's direct current, in which electrons always flow in one direction, from negative to positive.

In the contemporary world, generators range from the huge hydro electric turbines that power cities to the gas-powered emergency generators that consumers use during outages, to the generators which help to maintain the charge in our car batteries. All generators depend on a motive force to spin their coils. The force of flowing water rotates the fins in a hydro electric turbine, and the fins in turn rotate a revolving shaft that rotates the coils. Coal-fired or oil-fired power plants burn fuel to produce steam and the pressurized steam is then released to drive the turbines. Gas-powered generators use an internal combustion engine and a driveshaft to rotate generator coils, and the coils in a car's generator are spun by a driveshaft connected to a belt driven by the engine. To generate electricity, a generator requires an input of kinetic or mechanical energy.

The present invention, hereinafter referred to as the Hydro Electric Portable Generator, or Portable Hydro Electric Generator, is a self-contained generator which converts the gravitational potential energy of water into electrical power, while continually replenishing its water reservoir. The Hydro Electric Portable Generator is a free-standing, gravity-fed, micro-Hydro Electric turbine-style generator. The water is provided from an elevated tank and the flow pressure is provided through the penstock, a series of diminishing diameter reducer pipes, as the water approaches the turbine. The turbine turns a generator and with the help of a booster pump, the water flowing through the turbine is continually returned to the tank or reservoir. The Hydro Electric Portable Generator is comprised of an approximately five-hundred gallon cylindrical tank or reservoir, measuring approximately six feet in length and four feet in diameter. This tank is horizontally atop a hydraulic and mechanical lift that can raise the tank approximately twelve feet above its base. A vertically descending penstock, or downflow pipe, approximately twelve inches in diameter and eight feet in length, exits the bottom of the tank by means of a quick-release valve and diminishes to an elbow and reducer pipe, approximately six inches in diameter, designed to deliver the water to a low-flow turbine. The low-flow turbine has a driveshaft which rotates the coils of an electrical generator. The water exiting the turbine is then shunted back upward through an ascending fill pipe, which enters the upper level of the tank and continually refills the reservoir with the help of an in-line booster pump and the vacuum created by the fall of the water released from the tank. The main operating premise of the self refilling tank is that the system is closed, and that as the water exits the reservoir it will create a vacuum. This vacuum then draws the water back up into the tank. The First Law of Thermodynamics, sometimes called the Law of Conservation of Energy, states that energy can be neither created nor destroyed, but only converted from one form to another. With the Hydro Electric Portable Generator concept, the amount of potential energy stored in the water is proportional to its mass, the distance it has been raised, and the force of gravity pulling it down, the mathematical relationship being PE=mgh. The practical, ironclad result is twofold. First, the same amount of energy expended lifting the water to the height at which it is stored is equal to the amount of energy produced. Secondly, returning the water to that height will require the same amount of energy released with the downflow of the water. Further, in converting the kinetic energy of the flowing water to electricity a portion of the potential gravitational energy of the water is converted, as some energy will be dissipated in fluid turbulence and friction as it flows through the penstock and turns the turbine. The reason hydroelectric systems work is that the sun does all the lifting. Through evaporation and then precipitation in natural waterfalls and man made dams, the sun adds the potential energy that a reservoir of water contains, a potential that is converted to kinetic energy as the water falls. There is no way to overcome or circumvent the Law of Conservation of Energy. What comes out is what is put in. In the case of the Hydro Electric Portable Generator, there remain two alternatives for possible development. The first is to use the generator to power an electric pump for returning the water to the reservoir. Because the generator, as explained above, cannot produce one hundred percent efficiency, the pump is not capable of returning all the water; and gradually, as the volume in the tank diminishes, so will the generator's output and the pump's capacity. The system will cease to function until the reservoir is refilled by other means. The other alternative is to use a nearby, slightly elevated body of water, descending piping, and a hydraulic ram pump to fill the tank and thus power the generator. Hydraulic ram pumps are simple, mechanical and very wasteful of water, but in some localities such as rolling country where there are ponds but not much gradient for hydro power, this may be a viable prospect.

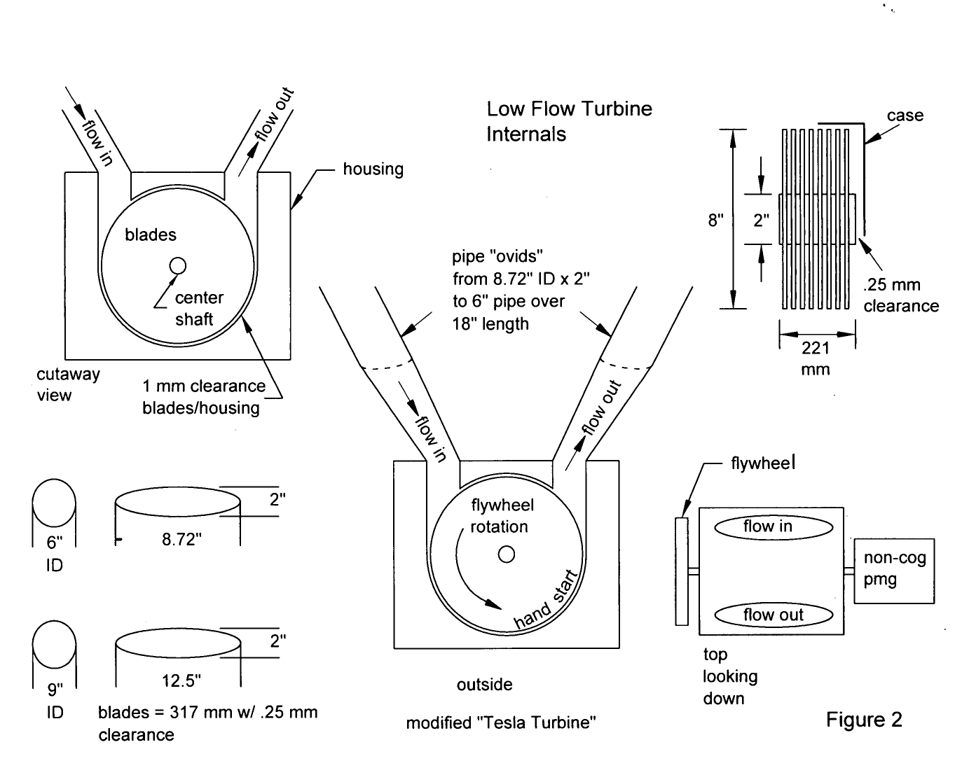

The invention will now be described in more detail. Starting with a 500 gallon tank of liquid used as a reservoir positioned about fifteen feet in the air measured from the bottom of the tank. The tank will have an air valve on it so that the system can be negatively pressured to about 20 psi (almost one negative atmosphere). This is to help create a partial vacuum in the system so that once the valve is opened the resulting movement of liquid out of the tank will increase the vacuum pull on the return pipe to help get the liquid back into the tank. One end of the tank needs to be positioned about six to eight inches lower than the other. Low side of the tank has an outlet pipe (12 inches diameter. I.D.) that is positioned at the bottom of the tank The outlet pipe has a ball valve attached inline to the pipe right at the bottom of low side of tank. After about a twelve foot down pipe you have an 18 inch long reduction pipe that goes from the twelve inch I.D. pipe to a six inch I.D. pipe. This will cause the liquid flowing in the pipe to increase in speed. After the reducer pipe there is an “ovide” (oval cross section) pipe conversion that will take the 6 inch I.D. round pipe (over an 18 inch length) and turn it into an oval pipe having dimension of 8.72 inch by 2 inch “I.D.” oval pipe in preparation to enter the turbine portion of the unit. FIG. 2. The outlet pipe from the turbine section is the same as the inlet pipe in reverse with the exception of the after the “ovide” pipe section it stays at a six inch I.D. pipe up to the tank connection.

The turbine portion of the unit is the prime mover for the generator. The turbine is basically a modified version of a “Tesla turbine” in the fact that the major difference is that the exit for the media used to run a “Tesla turbine” is in the center of the turbine disks and in the present invention it is at the other side of the turbine housing. See FIG. 2. This design provides two benefits over standard turbine designs. First, the disruption in flow of the liquid transferring flow to mechanical motion is almost seamless. With the blades of the turbine positioned in-line to the flow of liquid (as opposed to perpendicular to the flow as in a standard turbine) there is minimum loss of momentum to the flowing liquid. With blades positioned like this it is molecular cohesion/boundary layer effect that causes the blades to spin and stay spinning. On the outside of the turbine unit connected to the shaft of the blades is a flywheel to make use of centrifugal force in order to keep the turbine spinning. During the initial start of the unit the flywheel spin should be hand started to minimize energy loss at the start. The second benefit to this design of the turbine is that through the same forces that are being utilized to spin the blades, the blades also partially act as a pump to help keep the liquid moving on its way back to the holding tank.

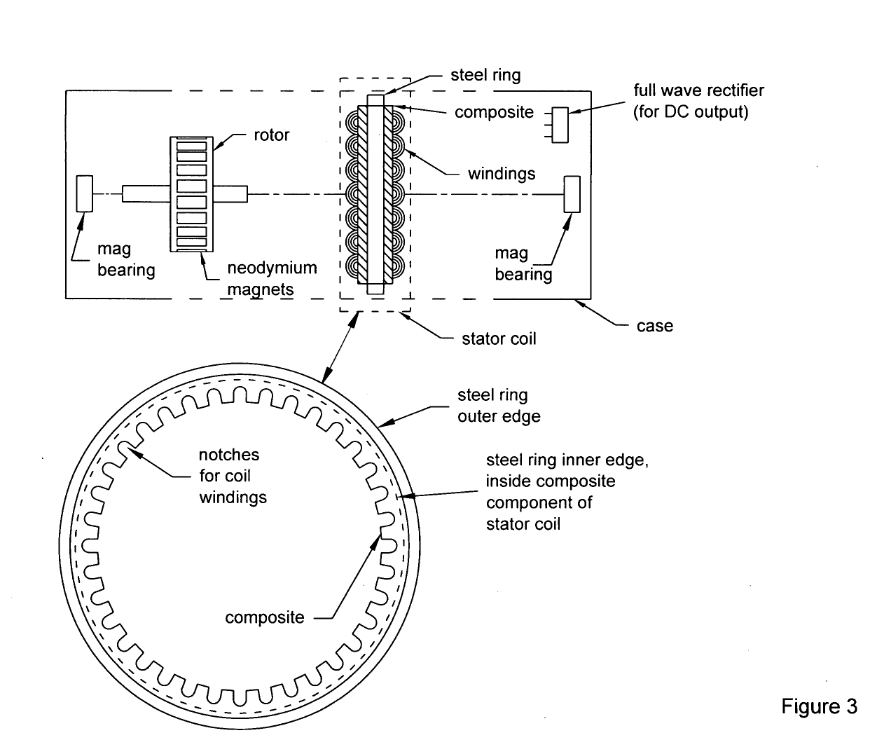

The generator portion of this unit is a non-cogging permanent magnet generator (PMG), shown in FIG. 3. The generator is connected to the same shaft as the turbine blades on the opposite side of turbine case from the flywheel. The importance of this generator being a “non-cogging” type is that this turbine only needs to overcome the initial inertial resistance of getting the generator spinning (or finish getting it up to speed after manually starting it by spinning the flywheel) as opposed to the need to constantly overcome the forces of the permanent magnets on the rotor trying to pull the stator of the generator to them while the rotor is spinning. The magnetic attraction of the rotor to the stator in a prior art PMG is overcome by the design of the present invention by using a stator mostly crafted of a composite material. The “steel” ring on the stator in FIG. 3 will not cause any “cogging” of the rotor because it is in its entirety equidistant from the rotor. The purpose of this ring is to give the case of the generator something to clamp in between the two halves to make sure the stator does not rotate and stays aligned to the rotor. Any non-ferrous metal or material can be used for this ring.

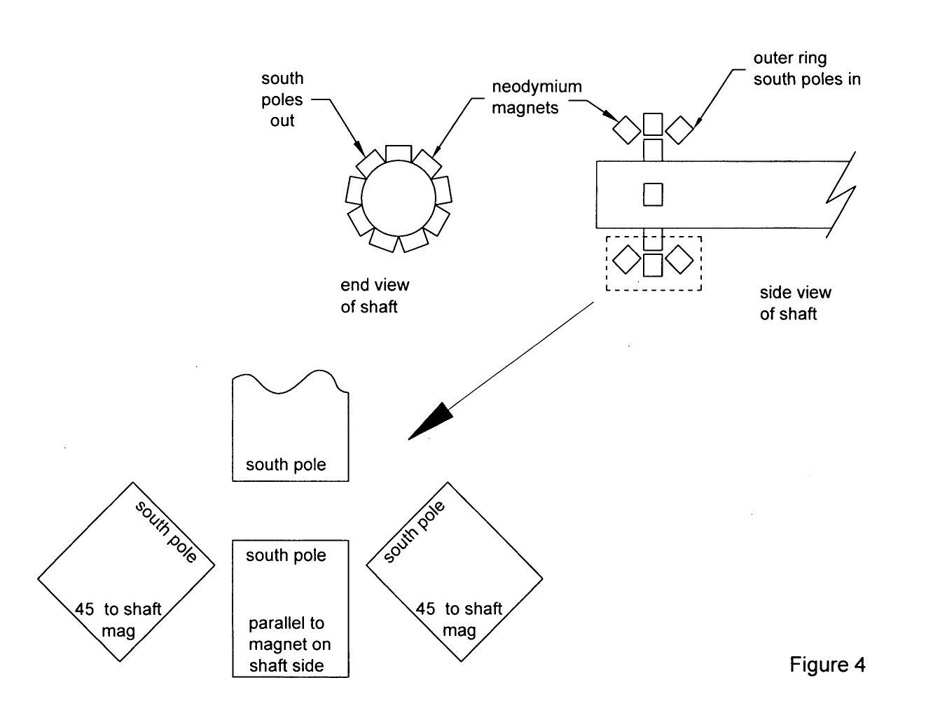

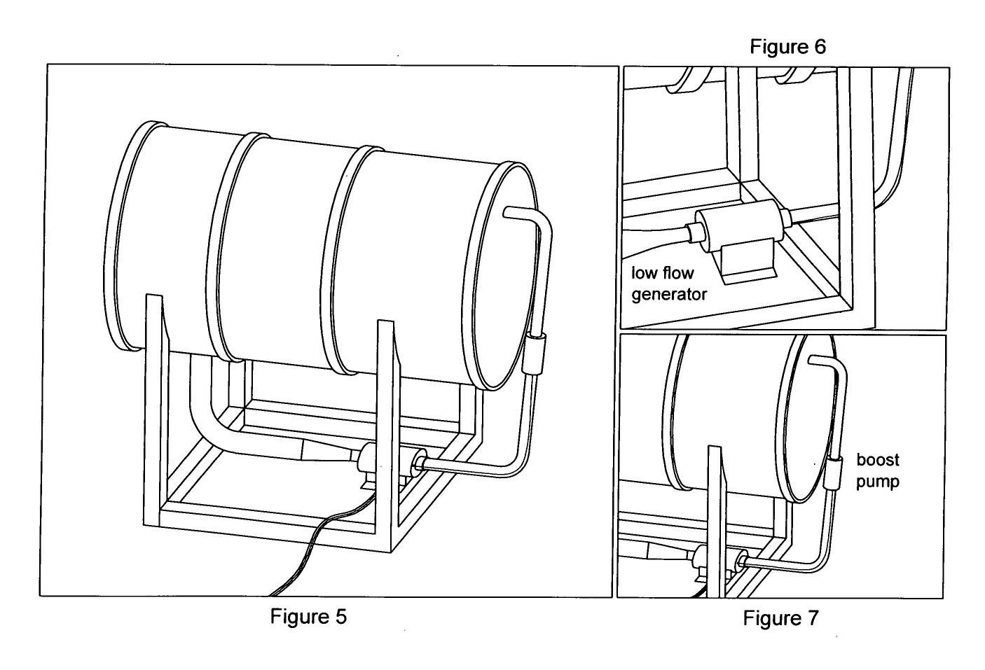

In order to further cut down on energy losses, the bearings in both turbine section and the generator section are magnet bearings. See this in FIG. 4. The basic set up for these consist of one row (ring) of multiple permanent magnets all having the same magnetic pole facing ut on the inner ring (shaft side) of the bearing. The outer ring (case side) of the bearing has three rows (rings) of permanent magnets that have the same pole facing toward the inner ring as the inner ring has facing out. The pole of one row is parallel in alignment to that of the inner row. The other polarities of the two rows are at 45 degree angles to the inner row, one on each side. The two outer rows are used as a stabilizer to ensure that there is minimal “wobble” in the bearing and that it stays true.

This Hydro Electric Portable Generator presents a highly efficient Hydro Electric Portable Generator which can have immense benefit to governmental and non-governmental relief agencies, to the military, and to impoverished regions of the globe.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A portable self-containing hydroelectric generator, comprising a self-contained generator which converts the gravitational potential energy of water into electrical power, while continually replenishing its water reservoir, wherein a free-standing, gravity-fed, micro-Hydro Electric turbine-style generator is supplied by water from an elevated tank and the flow pressure is provided through the penstock, a series of diminishing diameter reducer pipes, as the water approaches the turbine, and wherein the turbine turns a generator and with the help of a booster pump, the water flowing through the turbine is continually returned to the tank or reservoir.

2. The generator of claim 1 wherein the elevated tank is an approximately five-hundred gallon cylindrical tank or reservoir, measuring approximately six feet in length and four feet in diameter, and wherein the tank is horizontally atop a hydraulic and mechanical lift that can raise the tank approximately twelve feet above its base, and further comprising a vertically descending penstock, or downflow pipe, approximately twelve inches in diameter and eight feet in length, wherein the downflow pipe exits the bottom of the tank by means of a quick-release valve and diminishes to an elbow and reducer pipe, approximately six inches in diameter, designed to deliver the water to a low-flow turbine.

3. The generator of claim 2 further, wherein the low-flow turbine further comprises a driveshaft which driveshaft rotates the coils of an electrical generator, and wherein the water exiting the turbine is then shunted back upward through an ascending fill pipe, which enters the upper level of the tank and continually refills the reservoir with the help of an in-line booster pump and the vacuum created by the fall of the water released from the tank.

4. The generator of claim 1 wherein a 500 gallon tank having a first end and a second end of liquid used as a reservoir positioned about fifteen feet in the air measured from the bottom of the tank and wherein the tank will have an air valve on it so that the system can be negatively pressured to about 20 psi (almost one negative atmosphere), wherein the first end of the tank is positioned about six to eight inches lower than the second end, and wherein the first end of the tank has an outlet pipe (12 inches diameter. I.D.) that is positioned at the bottom of the tank, and wherein the outlet pipe has a ball valve attached inline to the pipe right at the bottom of first end of tank.

5. The generator of claim 4, wherein the outlet pipe of the tank is twelve inches I.D., and continues about twelve feet, and is followed by an 18 inch long reduction pipe that goes from the twelve inch I.D. pipe to a six inch I.D. pipe, wherein after the reduction pipe there is an “ovide” (oval cross section) pipe conversion that will take the 6 inch I.D. round pipe (over an 18 inch length) and turn it into an oval pipe having dimension of 8.72 inch by 2 inch “I.D.” oval pipe in preparation to enter the turbine portion of the unit.

6. The generator of claim 5, wherein the outlet pipe from the turbine section is the same as the inlet pipe in reverse with the exception of the after the “ovide” pipe section it stays at a six inch I.D. pipe up to the tank connection.

7. The generator of claim 2 wherein the outlet for the water is at the opposite side of the turbine housing opposite the inlet.

8. The generator if claim 7, further comprising a flywheel to make use of centrifugal force in order to keep the turbine spinning on the outside of the turbine unit connected to the shaft of the blades.

9. The generator of claim 1 comprising a non-cogging permanent magnet generator (PMG), wherein the generator is connected to the same shaft as the turbine blades on the opposite side of turbine case from the flywheel, wherein a stator is crafted of a composite material, or any non-ferrous metal or material and wherein the ring on the stator is in its entirety equidistant from the rotor.
